(19) United States
(12) Patent Application Publication
(10) Pub. No.: US 2016/0263997 A1
(43) Pub. Date: Sep. 15, 2016

(54) APPARATUS AND METHOD FOR CONTROLLING DISPLAY

(71) Applicant: FUJITSU LIMITED, Kawasaki-shi (JP)

(72) Inventor: Masami Mizutani, Kawasaki (JP)

(73) Assignee: FUJITSU LIMITED, Kawasaki-shi (JP)

(21) Appl. No.: 15/165,842

(22) Filed: May 26, 2016

Related U.S. Application Data
(63) Continuation of application No. PCT/JP2013/082445, filed on Dec. 3, 2013.

(51) Int. Cl. B60K 35/00; H04N 5/262; G06T 11/60; G06K 9/00; B60W 40/076; H04N 5/232

(52) U.S. Cl. CPC B60K 35/00; B60W 40/076; H04N 5/23293; G06T 11/60; G06K 9/00791; H04N 5/23229; H04N 5/262; B60K 2350/352; G06T 2210/22

(57) ABSTRACT

A display control apparatus includes a memory and a controller. The memory stores a source picture taken by a rear view camera attached to a vehicle. The controller detects a road gradient and calculates a first point on a road that is located at a predetermined distance from the vehicle, based on the detected road gradient. The controller then crops out a partial area of the source picture such that the partial area includes a second point on a straight line between the rear view camera and the first point on the road, and displays a picture of the partial area.

### CROSS-REFERENCE TO RELATED APPLICATION

This application is a continuation application of International Application PCT/JP2013/082445 filed on Dec. 3, 2013 which designated the U.S., the entire contents of which are incorporated herein by reference.

### FIELD

The embodiments discussed herein relate to a display control apparatus and a display control method.

### BACKGROUND

Electronics is playing an increasingly important role in today's automobiles. Conventionally, an automobile includes electronic control units (ECU) to control the ignition timing, fuel injection, engine rotation speed, and other things so as to keep its engine performance and fuel economy in good condition. In addition to those fundamental aspects of vehicles, recent automobile design has expanded the applications of electronic control to enhance the safety and improve the energy saving performance. As another example of electronification, automated driving and collision detection technologies have been tested for actual use.

As part of the trend for such electronic control, there is a move afoot to replace wing mirrors and rear-view mirrors (collectively referred to herein as “vision devices”) with electronic devices. Regulation No. 46 from the United Nations Economic Commission for Europe (UNECE) discusses the techniques for indirect vision to replace the functions of conventional mirrors. For example, the functions of wing mirrors may be provided by affixing cameras at the positions of wing mirrors and presenting their video output on display devices. Such electronic vision devices make it possible to apply computational processing to their video images before presenting them to the driver, and are thus expected to enable us to enhance the safety and comfort.

For example, a vehicular monitoring device has been proposed as one of the vision-based techniques for improved safety of motor vehicles. This device is to warn the driver of a vehicle climbing up a hill when there is another vehicle hidden beyond the top of the hill. More specifically, the proposed vehicular monitoring device uses a front view camera to capture and extract the image of an object that becomes more and more visible as the time passes, thereby recognizing a vehicle partially hidden by a concave part of the road.

There is also a proposed technique for controlling physical mirrors. This technique estimates a mirror image A seen in a rear view mirror, based on the gradient and curvature of the road, and modifies the orientation of the mirror so as to resolve a difference between the mirror image A and a predetermined mirror image B. As another example of related techniques, a view field providing device is proposed for providing the driver with a view in a specific range. This device selects and activates at least one of a plurality of view field providing means, including wing mirrors and a rear view mirror of the vehicle, as well as exterior cameras combined with display devices. See, for example, the following documents:

Japanese Laid-open Patent Publication No. 2008-132895

Japanese Laid-open Patent Publication No. 2009-279949

Japanese Laid-open Patent Publication No. 2009-280196

Suppose now that an automobile is traveling up or down a sloping road. The rear view the driver sees in a mirror is occupied by an image of the road in the case of uphill driving, or by an image of the sky in the case of downhill driving. In other words, the mirror offers the driver less rearward information when the automobile is climbing uphill or downhill than when it is cruising on a flat road. This fact may lead to a delay in the driver's recognition of a vehicle approaching from behind when driving on a slope, or bring some uneasiness to the driver because of the narrowness of rear views. As can be seen from the above discussion, better rear views in hill driving will contribute to an improved safety.

### SUMMARY

In one aspect, there is provided a display control apparatus including: a memory that stores a source picture taken by a rear view camera attached to a vehicle; and a controller configured to perform a procedure including: detecting a road gradient, calculating a first point on a road that is located at a predetermined distance from the vehicle, based on the detected road gradient, cropping out a partial area of the source picture such that the partial area includes a second point on a straight line between the rear view camera and the first point on the road, and displaying a picture of the partial area.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an example of a display control apparatus according to a first embodiment;

FIGS. 2 and 3 are first and second diagrams illustrating an example of vehicle-mounted devices according to a second embodiment;

FIGS. 4 to 10 are first to seventh diagrams illustrating functions of a view field providing unit according to the second embodiment;

FIGS. 11 to 17 are first to seventh diagrams illustrating a process flow executed by a view field providing unit according to the second embodiment;

FIGS. 18 and 19 are first and second diagrams illustrating a view field providing method according to variation #1 of the second embodiment;

FIG. 20 illustrates a view field providing method according to variation #2 of the second embodiment; and

FIG. 21 illustrates a hardware configuration of an information processing apparatus according to variation #3 of the second embodiment.

### DESCRIPTION OF EMBODIMENTS

Several embodiments will be described below with reference to the accompanying drawings. Although this specification describes various elements illustrated in the drawings, some of those elements may be substantially the same in terms of their functions. Such similar elements may be referred to by the same reference numerals, and their descriptions are not repeated even if they appear in the embodiments multiple times.

### 1. First Embodiment

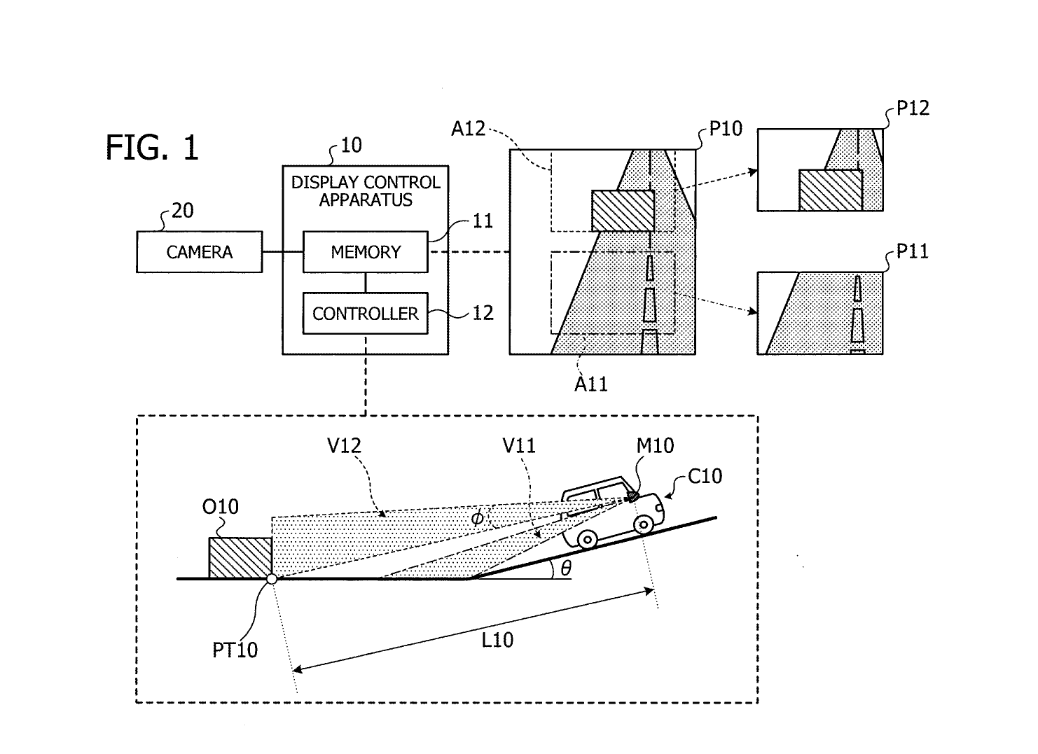

Referring to FIG. 1, a first embodiment will now be described below. FIG. 1 illustrates an example of a display control apparatus according to the first embodiment. The illustrated display control apparatus 10 includes a memory 11 and a controller 12. Note that the functions of the display control apparatus 10 may be incorporated into an electronic control unit (ECU) used in the illustrated vehicle C10.

The memory 11 is a volatile storage device (e.g., random access memory, RAM) or a non-volatile storage device (e.g., hard disk drive, HDD, and flash memory). The controller 12 may be a central processing unit (CPU), digital signal processor (DSP), or any other processor. The controller 12 may also include an application-specific integrated circuit (ASIC), field-programmable gate array (FPGA), or other similar electronic circuits. For example, the controller 12 executes programs stored in the memory 11 or any other storage device.

The memory 11 stores a source picture P10 taken with a rear view camera 20 of the vehicle C10. For example, this camera 20 is attached to a mirror part M10 of the vehicle C10, at which a wing mirror would be placed in the case of typical automobiles. The camera 20 may have, for example, a set of wide-angle lenses with a short focal length so as to capture rear view images in a wider range than typical wing mirrors would do. The camera 20 may be a digital video camera capable of continuously producing video images of rear view.

The controller 12 detects road gradients θ. For example, the controller 12 captures information about traveling speeds of the vehicle C10, as well as acceleration that the vehicle C10 undergoes. The acceleration is the net result of all forces acting on the vehicle C10, including gravity and other forces that change its velocity. For example, a three-dimensional acceleration sensor may be used to observe the acceleration. The controller 12 detects road gradients θ on the basis of observed traveling speeds and accelerations.

The controller 12 also calculates, based on road gradients θ, a point PT10 on the road that is at a predetermined distance of L10 from the vehicle C10. For example, the shape of the road behind the current position of the vehicle C10 may be estimated from a time series of traveling speeds and road gradients θ. This estimated road shape enables calculation of a point PT10 at a predetermined distance of L10 away from the vehicle's current location. The distance L10 may be a straight line distance from vehicle C10 to point PT10 (as in FIG. 1) or may be an actual distance along the curve of the road.

After the calculation of on-the-road point PT10, the controller 12 crops out a partial area A12 of the picture P10 such that the resulting partial picture includes a point on a straight line between the camera 20 and the point PT10. This image cropping is performed with a specific viewing angle φ, which may be defined previously as a fixed angle. Then the controller 12 outputs a picture P12 of the partial area A12. For example, the controller 12 may use an in-car monitor (not illustrated) or a display screen of an automotive navigation system in the vehicle C10.

The partial area A12, if properly positioned in the above-described way, will provide image information seen in a view field V12. However, if the cropping was done for a partial area A11 of the source picture P10 to obtain a view field V11 similarly to typical wing mirrors of a vehicle, most part of the resulting picture P11 would be occupied by an image of the road. In contrast, the foregoing picture P12 that the present embodiment extracts from the partial area A12 contains rich rear-view information, thus making it easier for the driver to recognize the presence of an object O10 in the example of FIG. 1.

That is, the proposed display control apparatus 10 provides the driver of the vehicle C10 with better rear views while climbing a slope, thus contributing to an improved safety. While FIG. 1 illustrates a vehicle C10 climbing an uphill road, the same display control apparatus 10 similarly provides better rear views when it descends a downhill road. The example of FIG. 1 places a camera 20 at the wing mirror position (mirror part M10). However, the embodiment may be modified to place it at some other position where a mirror resides.

The above description has explained the first embodiment.

### 2. Second Embodiment

This part describes a second embodiment.

2-1. Example of Vehicle-Mounted Devices

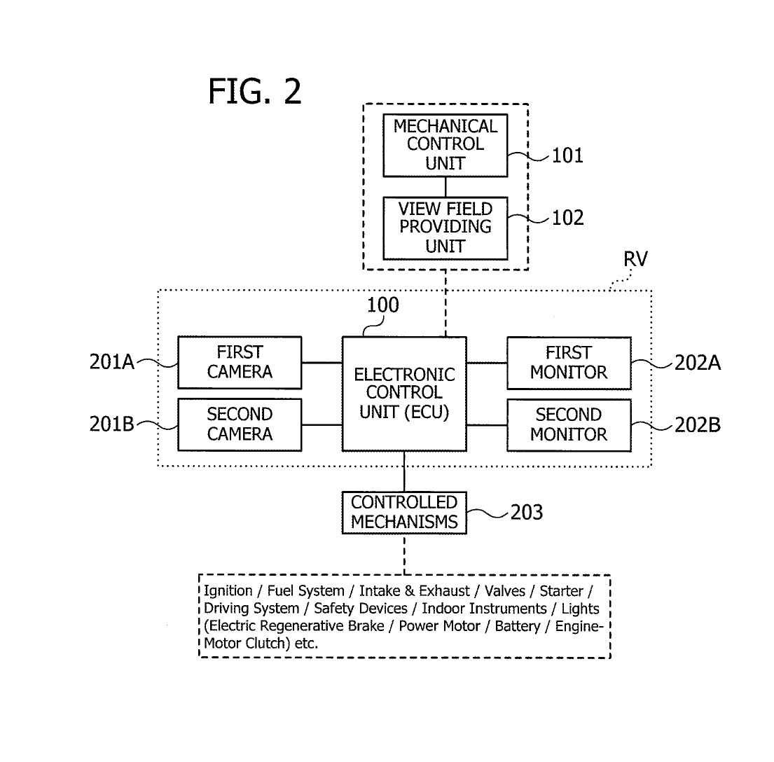

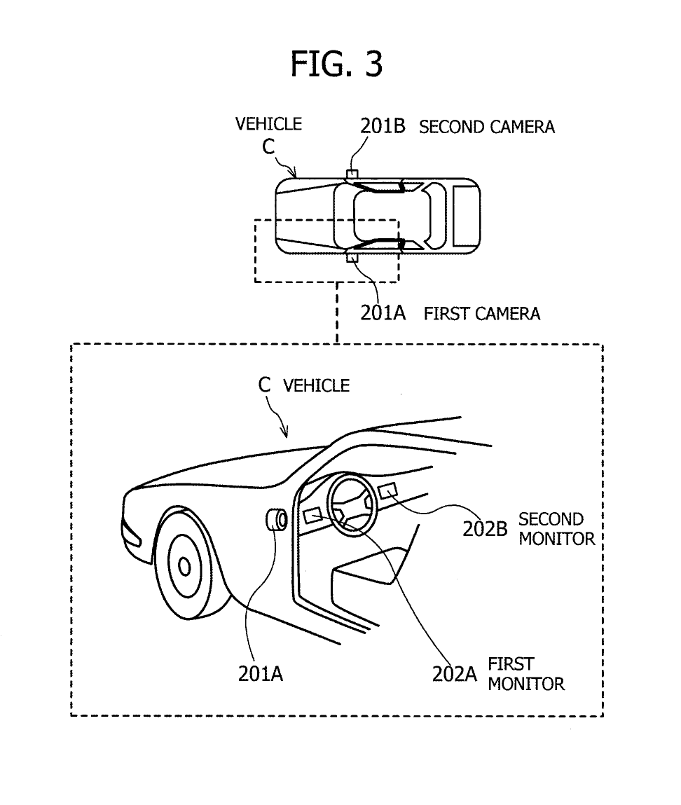

Referring first to FIGS. 2 and 3, vehicle-mounted devices according to the second embodiment will be described below. In the following description, the term “vehicle-mounted devices” refers collectively to the devices mounted in a vehicle C such as an automobile.

FIGS. 2 and 3 are first and second diagrams illustrating an example of vehicle-mounted devices according to the second embodiment. Referring to FIG. 2, the illustrated vehicle-mounted devices of vehicle C include an electronic control unit 100, a first camera 201A, a second camera 201B, a first monitor 202A, a second monitor 202B, and controlled mechanisms 203. The electronic control unit 100, first camera 201A, second camera 201B, first monitor 202A, and second monitor 202B may be referred to as a rear-viewing device RV in this description. The rear-viewing device RV is an example of the foregoing display control apparatus.

For example, the electronic control unit 100 may be implemented as a single ECU or multiple ECUs. The electronic control unit 100 electronically controls various mechanisms 203 in the vehicle, including ignition mechanisms, fuel system, intake and exhaust system, valve mechanisms, starter mechanisms, driving mechanisms, safety devices, indoor instruments, lights, and other things. These things are referred to as “controlled mechanisms” 203. Specifically, the electronic control unit 100 controls the amount of fuel supplied from the fuel system, as well as fuel injection timing and ignition timing. As to the intake and exhaust system, the electronic control unit 100 controls throttle openness and boost pressure of a supercharger, and the like. For the valve mechanism, the electronic control unit 100 undertakes valve timing control and valve lift control, and the like.

In addition, the electronic control unit 100 controls the starter motor and other part of the starter mechanism, as well as the clutch and other driving mechanisms. Safety devices include, for example, an antilock brake system (ABS) and airbags. These things are also under the control of the electronic control unit 100. The electronic control unit 100 further controls indoor instruments, including an air conditioner, tachometer, speedometer, and the like. Also controlled is the lighting system of the vehicle C, including direction indicators and other lights.

The vehicle C may be a hybrid car or an electric vehicle. In that case, the electronic control unit 100 further controls its power motor, electric regenerative brake, and clutch between engine and motor, besides managing batteries. The electronic control unit 100 includes a mechanical control unit 101 and a view field providing unit 102. The mechanical control unit 101 takes care of the above-described controlled mechanisms 203, while the view field providing unit 102 functions as part of a rear-viewing device RV.

Specifically, the view field providing unit 102 controls a first camera 201A, a second camera 201B, a first monitor 202A, and a second monitor 202B. The first camera 201A and second camera 201B are imaging devices, each formed from an optical system, an imaging sensor, analog-to-digital converters (ADC), a signal processor, and the like. The optical system is a collection of components for guiding light, such as lenses and an iris diaphragm. The imaging sensor is a charge-coupled device (CCD) or a complementary metal oxide semiconductor (CMOS) device for photoelectric conversion. The ADCs are circuits that convert electrical output signals of the imaging sensor into digital signals. The signal processor is a circuit that produces image data from digital output signals of the ADCs by performing signal processing such as image quality adjustment and image coding. The output image data from the first camera 201A and second camera 201B are referred to as “source pictures” in the following description.

For example, the first monitor 202A and second monitor 202B may be cathode ray tubes (CRT), liquid crystal displays (LCD), plasma display panels (PDP), electro-luminescence displays (ELD), or the like. It is also possible to use a display device of the automotive navigation system mounted in the vehicle C as the first monitor 202A and the second monitor 202B.

Source pictures taken by the first camera 201A are entered to the electronic control unit 100. The electronic control unit 100 crops out a partial area of each entered source picture and outputs the result to a screen on the first monitor 202A. This partial area is referred to as a “presentation range,” and the extracted picture is referred to as a “presentation picture.” That is, the presentation range of pictures from the first camera 201A is extracted and displayed on the first monitor 202A.

Likewise, source pictures taken by the second camera 201B are also entered to the electronic control unit 100. The electronic control unit 100 crops out a partial area of each entered source picture and outputs the resulting presentation picture to a screen on the second monitor 202B. That is, the presentation range of pictures from the second camera 201B is extracted and displayed on the second monitor 202B.

The first camera 201A and second camera 201B are placed at the locations of wing mirrors, directed in the rearward direction of the vehicle C as depicted in FIG. 3, for example. In this example of FIG. 3, the first camera 201A is located on the left side surface of the vehicle C, and the second camera 201B on the right side surface of the same. The first monitor 202A and second monitor 202B may be mounted at comfortable locations for the driver as depicted in FIG. 3, for example. In this example, the first monitor 202A is placed at the left of the steering wheel, while the second monitor 202B at the right of the same.

The above-described arrangement of components enables the driver to see pictures on the first monitor 202A located at the left of the steering wheel, the pictures being taken by the first camera 201A mounted on the left side surface of the vehicle C. Similarly, the driver can also see pictures on the second monitor 202B located at the right of the steering wheel, the pictures taken by the second camera 201B mounted on the right side surface of the vehicle C. In other words, FIG. 3 depicts an example of a vehicle C whose two wing mirrors are replaced with a first camera 201A, second camera 201B, first monitor 202A, and second monitor 202B.

The rest of this description will assumes this particular arrangement of the first camera 201A, second camera 201B, first monitor 202A, and second monitor 202B in FIG. 3. The second embodiment is, however, not limited by that assumption, but the positions and number of cameras and monitors may be changed. For example, the cameras may be placed at the rear-view mirror position or some other points at the rear end of the vehicle. The monitors may be implemented as part of an automotive navigation system. Further, three or more cameras and monitors may be mounted inside or outside the vehicle C. All these variations fall within the scope of the second embodiment.

The above description has discussed vehicle-mounted devices according to the second embodiment.

2-2. Functions of View Field Providing Unit

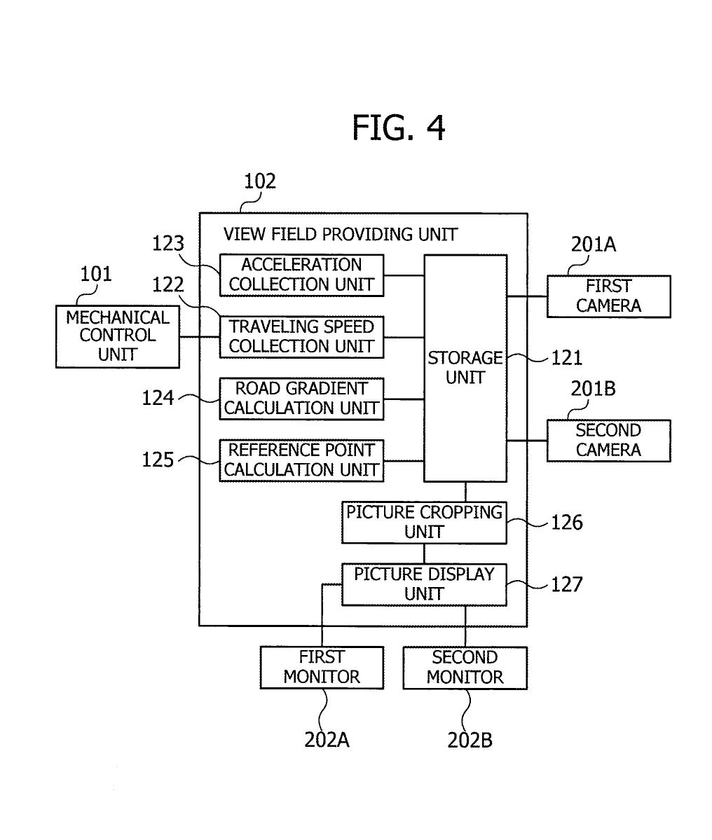

Referring now to FIGS. 4 to 10, this section describes functions that the view field providing unit 102 offers as part of the electronic control unit 100. FIGS. 4 to 10 are first to seventh diagrams that illustrate functions of a view field providing unit according to the second embodiment.

As seen in FIG. 4, the illustrated view field providing unit 102 includes a storage unit 121, a traveling speed collection unit 122, an acceleration collection unit 123, a road gradient calculation unit 124, a reference point calculation unit 125, a picture cropping unit 126, and a picture display unit 127.

Functions of the storage unit 121 may be implemented by using RAM or other volatile storage devices. They may also be implemented by using HDD, flash memory, or other non-volatile storage devices. Functions of the traveling speed collection unit 122, acceleration collection unit 123, road gradient calculation unit 124, reference point calculation unit 125, picture cropping unit 126, and picture display unit 127 may be implemented by using a CPU, DSP, or any other processor. Electronic circuits, such as ASIC and FPGA, may also be used to implement functions of the traveling speed collection unit 122, acceleration collection unit 123, road gradient calculation unit 124, reference point calculation unit 125, picture cropping unit 126, and picture display unit 127.

The storage unit 121 provides a storage space for source pictures taken by the first camera 201A and second camera 201B. The traveling speed collection unit 122 interacts with the mechanical control unit 101 to collect information about the traveling speed of the vehicle C. For example, the instantaneous speed displayed on the vehicle's speedometer may be collected. The collected traveling speed information is stored into the storage unit 121.

The acceleration collection unit 123 has a three-axis acceleration sensor or any other accelerometer to collect the acceleration of the vehicle C. Accelerometers suitable for the purpose include, for example, three-axis Piezoresistive acceleration sensors, three-axis capacitive acceleration sensors, and three-axis thermal acceleration sensors. The collected acceleration information is stored into the storage unit 121.

The road gradient calculation unit 124 calculates road gradients on the basis of acceleration information stored in the storage unit 121. The calculated road gradient information is stored into the storage unit 121. Algorithms used in this calculation will be described later.

The reference point calculation unit 125 calculates a point on the road, at a predetermined distance behind the current location of the vehicle C. This point is referred to as the “reference point.” The reference point calculation unit 125 first estimates the shape of the road, based on a time series of road gradient data and traveling speed data accumulated in the storage unit 121, and then calculates a reference point from the estimated road shape. The calculated reference point information is stored into the storage unit 121. Algorithms used in this reference point calculation will be described later.

The picture cropping unit 126 determines a presentation range of source pictures (i.e., which part of the pictures to present to the driver) on the basis of reference point information in the storage unit 121. The picture cropping unit 126 then trims the source pictures to extract the determined presentation range, thereby producing presentation pictures. The produced presentation pictures are then passed to the picture display unit 127. Algorithms for this determination of a presentation range will be described later.

The produced presentation pictures include those derived from source pictures taken by the first camera 201A and those derived from source pictures take by the second camera 201B. The picture display unit 127 outputs the former group of presentation pictures to the first monitor 202A and the latter group of presentation pictures to the second monitor 202B.

(a) Calculation of Road Gradient

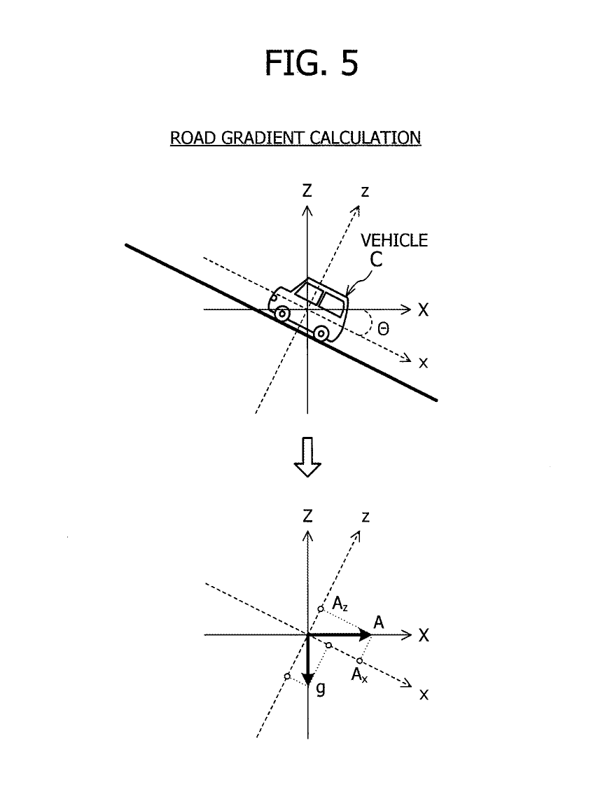

Referring now to FIG. 5, this subsection describes how to calculate a road gradient. The term “road gradient” refers to the inclination of a road (e.g., slope angle Θ in FIG. 5) with respect to the horizontal plane (i.e., plane perpendicular to the gravity direction).

Let us consider two coordinate systems, (x, z) and (X, Z), as illustrated in FIG. 5. Specifically, x axis is directed opposite to the motion of a vehicle C, and z axis is perpendicular to the x axis. X axis is on the x-z plane, and Z axis is perpendicular to the X axis. Let 0 represent the angle made by x axis and X axis.

Also, let Aₓ, A_{z}, and A represent the accelerations in x axis, z axis, and X axis, respectively. These accelerations Aₓ, A_{z}, and A are obtained from the aforementioned three-axis acceleration sensor and have the relationship expressed in equations (1) and (2), where g represents the gravitational acceleration. These equations (1) and (2) are then transformed into equations (3) and (4) seen below. The road gradient calculation unit 124 reads the values of accelerations Aₓ and A_{z} out of the storage unit 121 and enters them into equations (3) and (4), together with gravitational acceleration g, thus calculating slope angle Θ.

$$\begin{matrix}{A}_{x} = g \cdot sin Θ + A \cdot cos Θ & ( 1 ) \\ {A}_{z} = - g \cdot cos Θ + A \cdot sin Θ & ( 2 ) \\ A = \sqrt{{A}_{x}^{2} + {A}_{Z}^{2} - {g}^{2}} & ( 3 ) \\ Θ = {cos}^{- 1} \{ \frac{A \cdot {A}_{x} - g \cdot {A}_{z}}{{A}^{2} + {g}^{2}} \} & ( 4 )\end{matrix}$$

An example of a method for calculating road gradients has been described above.

(b) Calculation of Reference Point

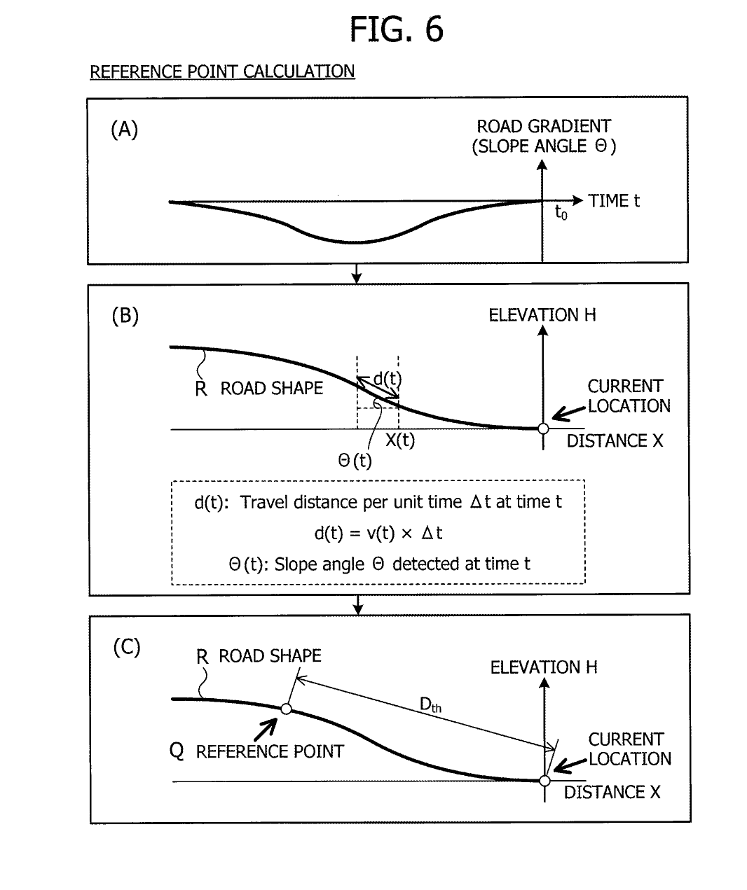

Referring now to FIG. 6, this subsection describes how to calculate a reference point. The description assumes the following notation of symbols. That is, symbol Θ(t) represents the slope angle of the road (or “road gradient”) at a specific time t. Symbol v(t) represents the traveling speed at time t. Symbol d(t) represents the distance that the vehicle C travels per unit time Δt. Symbol H(t) represents the elevation of a specific point on the road at which the vehicle C resides at time t, relative to the vehicle's current location. Symbol X(t) represents the X-axis distance from the current location of the vehicle C (see FIG. 5). Note that the term “current location” refers to where the vehicle C resides at time to.

Suppose, for example, that the vehicle C goes down a slope. Part (A) of FIG. 6 gives a graph of slope angle Θ(t) in this case. Travel distance d(t) at time t is calculated as v(t)×Δt. The on-the-road location (H(t−1), X(t−1)) of vehicle C at time (t−1) is estimated to be d(t) behind the point (H(t), X(t)) in the direction of Θ(t) as seen in part (B) of FIG. 6. The reference point calculation unit 125 uses the above method to estimate elevation H(t) and distance X(t) at time t on a step-by-step basis.

Now that elevation H(t) and distance X(t) have been calculated, the reference point calculation unit 125 then calculates the length D(t) of a line between the current location and the last estimated point. The reference point calculation unit 125 also determines whether the calculated length D(t) coincides with a predetermined distance Dₜₕ, where a certain amount of tolerance is allowed. When D(t) coincides with Dₜₕ, the reference point calculation unit 125 determines that estimated point to be the reference point Q as seen in part (C) of FIG. 6. When D(t) does not coincide with Dₜₕ, the reference point calculation unit 125 continues the above estimation and seeks another point.

The reference point calculation unit 125 stores the resulting time-series data of such estimated elevation H(t) and distance X(t) into the storage unit 121. The reference point calculation unit 125 also uses the storage unit 121 to store information about the determined reference point Q.

The above-described procedure tests the coincidence between length D(t) and specified distance Dₜₕ each time a new estimate of elevation H(t) and distance X(t) is produced. The method may, however, be modified such that it first calculates a road shape R until the integration of distance X(t) exceeds a specified distance Dₜₕ and then determines a reference point Q from the road shape R. The method may further be modified to follow the curve of road shape R when calculating a distance D(t) between the current location and reference point Q, instead of using their linear distance as in the example of FIG. 6.

The above description has explained how to calculate a reference point.

(c) Determination of Presentation Range

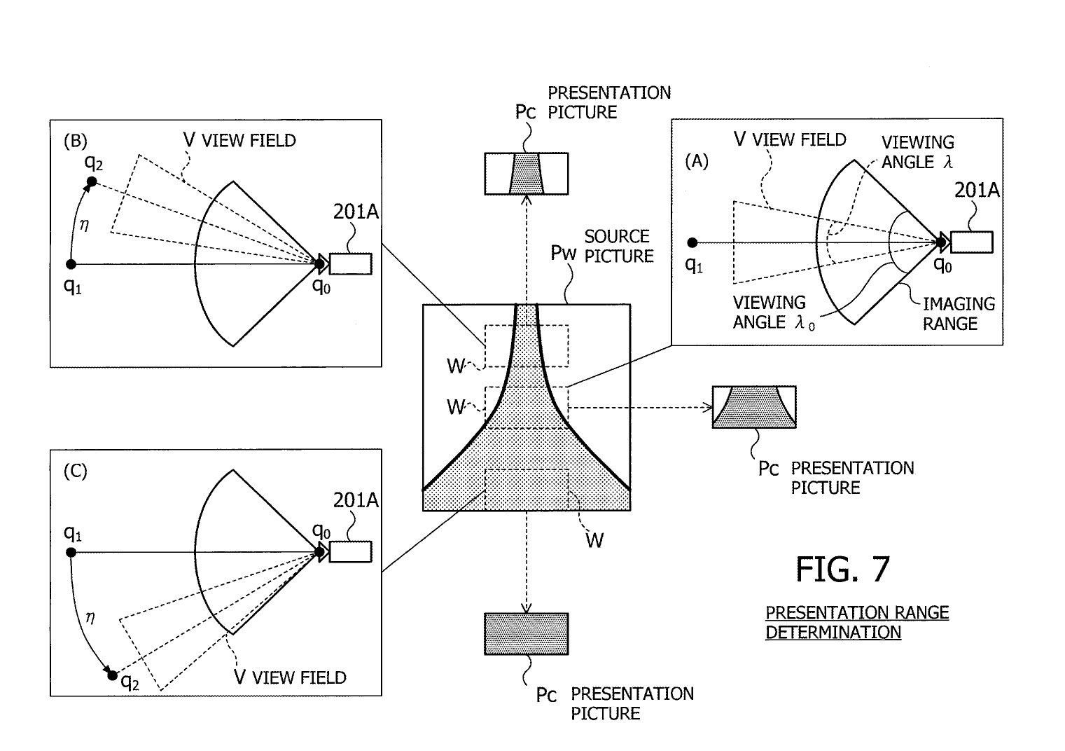

Referring now to FIGS. 7 to 10, this subsection describes a method for determining a presentation range. Let us consider a presentation range for extraction of a presentation picture Pc from a given source picture Pw as seen in FIG. 7. For explanatory purposes, the source picture Pw is assumed to be taken by the first camera 201A.

To replace a wing mirror with the first camera 201A and first monitor 202A, the method of presentation range determination has to satisfy some legal requirements for wing mirrors. For example, the driver is supposed to recognize an object located at a specific distance (e.g., 50 m) behind the vehicle. Taking such requirements into consideration, the proposed picture cropping unit 126 determines a presentation range W corresponding to a view field V with a fixed viewing angle λ, as illustrated in part (A) of FIG. 7. Here an appropriate value is selected for the viewing angle λ such that an image of an object would appear with a prescribed size in the presentation range W if the object sits at a specific distance behind the vehicle.

As also seen in part (A) of FIG. 7, an appropriate focal length is selected for the first camera 201A such that the raw viewing angle λ0 will be greater than the effective viewing angle λ corresponding to the presentation range W. Symbol q₀ represents the position of the first camera 201A (the lens position in the example of FIG. 7), and symbol q₁ represents a point on the frontal optical axis of the first camera 201A. Symbol q₂ represents a point on the center line of view field V corresponding to the presentation range W as seen in part (B) of FIG. 7. Then two line segments q₀-q₁ and q₀-q₂ form an angle η.

The picture cropping unit 126 determines a desirable presentation range W while varying the angle η formed by two line segments q₀-q₁ and q₀-q₂. In this process, the picture cropping unit 126 varies the angle η as far as the moved view field V falls within the original view field of the first camera 201A (i.e., the imaging range depicted in FIG. 7). Note that the angle η takes a positive (+) value when the line segment q₀-q₂ is above the line segment q₀-q₁ as seen in part (B) of FIG. 7 and a negative (−) value when the line segment q₀-q₂ is below the line segment q₀-q₁ as seen in part (C) of FIG. 7. After the presentation range W is determined, the picture cropping unit 126 produces a presentation picture Pc by cropping out the presentation range W from the source picture Pw.

FIG. 7 illustrates an example of how the presentation picture Pc changes when the angle η is varied in positive and negative directions, where the source picture Pw is taken by the first camera 201A of vehicle C climbing a slope. The hatched areas in FIG. 7 represent the road. Part (A) of FIG. 7 indicates the case of η=0, in which the resulting presentation picture Pc is occupied by an image of the road and thus provides the driver with a limited rear view. Part (C) of FIG. 7 indicates that the presentation picture Pc would be even more occupied by the road as the angle η changes in the negative direction. In contrast, part (B) of FIG. 7 demonstrates that a positive change of the angle η would reduce the ratio of road images in the presentation picture Pc, thus providing the driver with a desirable rear view.

As seen from the example of FIG. 7, the driver will be able to see a better rear view by changing the angle η in a positive direction, contributing to improved safety and reduced uneasiness. However, overly large variations of angle η in the positive direction would lose the presentation picture Pc a near part of the rear view. It would also be possible that the foregoing point of legal requirements goes out of the presentation picture Pc. Optimal angle η may vary depending on where in the uphill road the vehicle is climbing. This is also true for downhill roads. The picture cropping unit 126 therefore controls the angle η in an optimal way, taking these things into consideration.

(d) Uphill Road

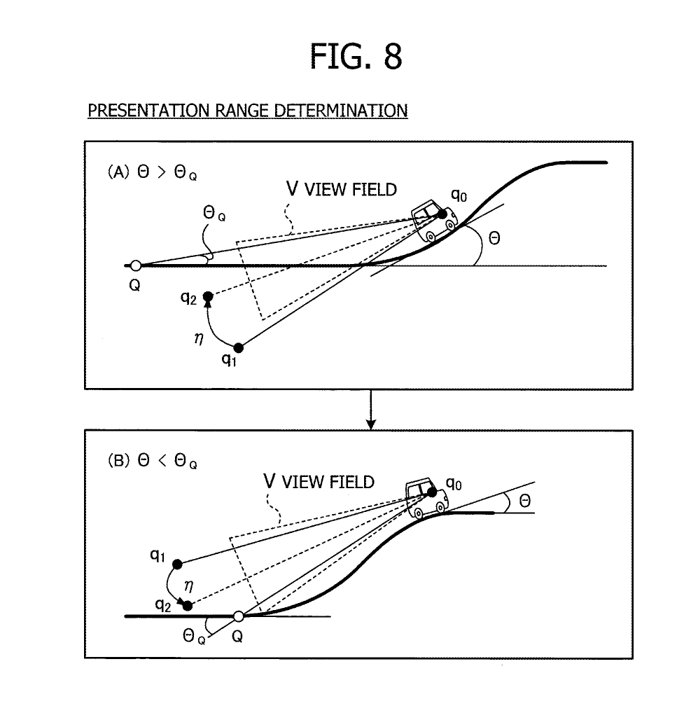

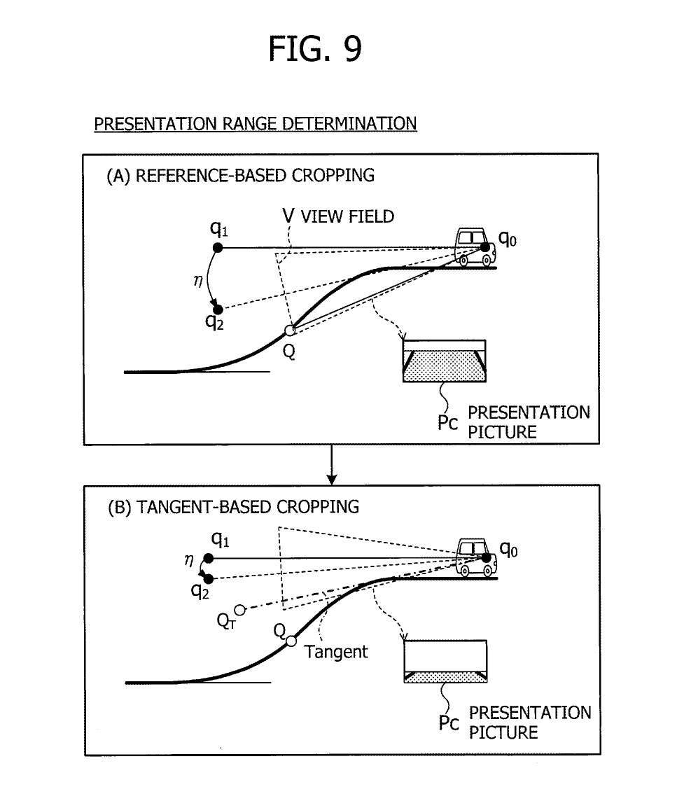

Referring now to FIGS. 8 and 9, this subsection describes a method for determining a presentation range W for a vehicle C climbing an uphill road. The description uses the symbol Θ_{Q} to refer to an angle that the line segment (q₀-Q) between point q₀ and reference point Q forms with respect to the horizontal plane. It is also assumed that an optimal presentation picture Pc is obtained with angle η=0 when the vehicle C sits on a horizontal plane. In other words, the first camera 201A is properly oriented in such a way that the driver can obtain a desirable rear view when the vehicle C is on a horizontal plane.

Part (A) of FIG. 8 illustrates a situation in which the vehicle C has begun to climb an uphill road (Θ>Θ_{Q}). In this situation, the presentation picture Pc obtained with angle η=0 (i.e., when the view field is directed in the direction of a line segment q₀-q₁) would be occupied mostly by the road's image. Accordingly, the picture cropping unit 126 varies the angle η in the positive direction so that the line segment q₀-Q be contained in the view field V. The picture cropping unit 126, however, limits this angular variation at a minimum. More specifically, an appropriate angle η is selected such that the upper boundary of view field V comes close to the line segment q₀-Q as seen in part (A) of FIG. 8.

Large variations of angle η would produce significant changes in the presentation picture Pc and thus could confuse the driver in recognizing what he or she is seeing. The picture cropping unit 126 is, however, configured to minimize the variation of angle η to avoid such changes of the presentation picture Pc and reduce the driver's confusion, thus contributing to an improved safety.

Part (B) of FIG. 8 illustrates a situation in which the vehicle C is nearing the end of the uphill road (Θ<Θ_{Q}). In this situation, the presentation picture Pc obtained with angle η=0 (i.e., when the view field is directed in the direction of a line segment q₀-q₁) would be occupied mostly by the image of an upper space (e.g., sky) far above the road. Accordingly, the picture cropping unit 126 varies the angle η in the negative direction so that the line segment q₀-Q be contained in the view field V. The picture cropping unit 126, however, limits this angle at a minimum. More specifically, an appropriate angle η is selected such that the lower boundary of view field V comes close to the line segment q₀-Q as seen in part (B) of FIG. 8.

Large variations of angle η would produce significant changes in the presentation picture Pc and thus could confuse the driver in recognizing what he or she is seeing. The picture cropping unit 126 is, however, configured to minimize the variation of angle η to avoid such changes of the presentation picture Pc and reduce the driver's confusion, thus contributing to an improved safety.

The line segment q₀-Q is referred to as a “reference line.” The above method discussed in part (B) of FIG. 8 determines the angle η with respect to this reference line. If the same method continues even after the vehicle C has finished slope climbing, the resulting presentation picture Pc would be occupied mostly by an image of the road since the reference line would cross the top of the slope as seen in part (A) of FIG. 9. The proposed picture cropping unit 126 therefore calculates a tangent to the uphill road (or line segment q₀-Q_{T}) as seen in part (B) of FIG. 9 and determines the angle η with respect to the calculated line segment q₀-Q_{T}. That is, the picture cropping unit 126 gives a negative angle η so that the line segment q₀-Q_{T} be contained in the view field V. The picture cropping unit 126, however, limits this angular variation at a minimum. More specifically, an appropriate angle η is selected such that the lower boundary of view field V comes close to the line segment q₀-Q_{T} as seen in part (B) of FIG. 9.

Large variations of angle η would produce significant changes in the presentation picture Pc and thus could confuse the driver in recognizing what he or she is seeing. The picture cropping unit 126 is, however, configured to minimize the variation of angle η to avoid such changes of the presentation picture Pc and reduce the driver's confusion, thus contributing to an improved safety.

The angle η is varied in the way described above, so that the driver can obtain desirable views behind his or her vehicle C. The resulting presentation pictures Pc always contain a point at a predetermined distance from the vehicle C even when it is climbing up an uphill road.

(e) Downhill Road

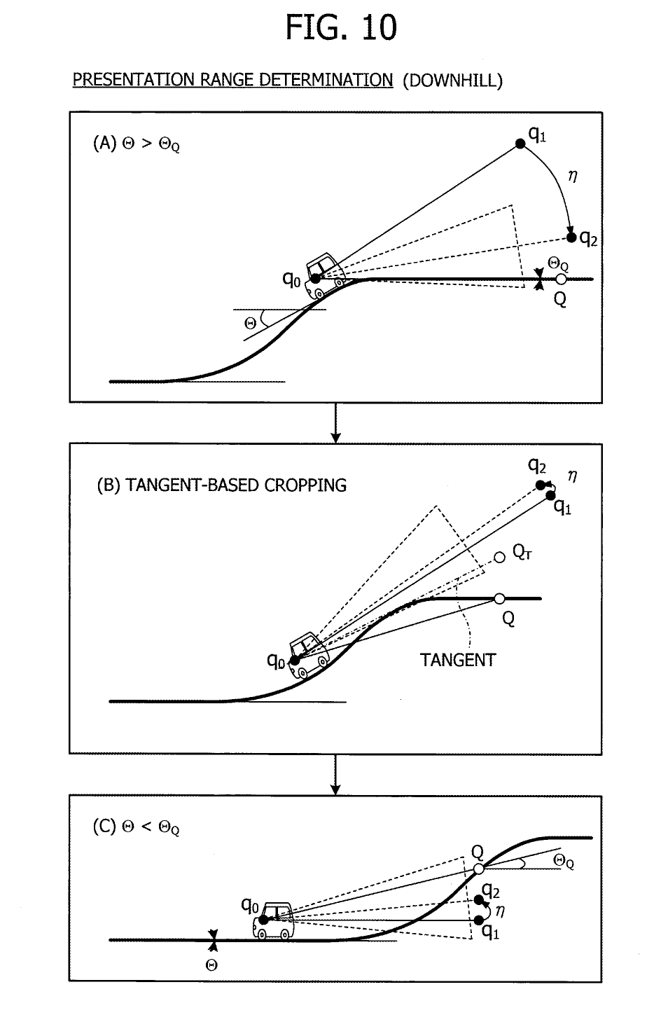

Referring now to FIG. 10, this subsection describes how to determine a presentation range W when the vehicle C goes down a downhill road.

Part (A) of FIG. 10 illustrates a situation in which the vehicle C has begun to descend a downhill road (Θ>Θ_{Q}). In this situation, the presentation picture Pc obtained with angle η=0 (i.e., when the view field is directed in the direction of a line segment q₀-q₁) would be occupied mostly by the image of an upper space (e.g., sky) far above the road. Accordingly, the picture cropping unit 126 varies the angle η in the negative direction so that the line segment q₀-Q be contained in the view field V. The picture cropping unit 126, however, limits this angular variation at a minimum. More specifically, an appropriate angle η is selected such that the line segment q₀-Q comes close to the lower boundary of view field V as seen in part (A) of FIG. 10.

Large variations of angle η would produce significant changes in the presentation picture Pc and thus could confuse the driver in recognizing what he or she is seeing. The picture cropping unit 126 is, however, configured to minimize the variation of angle η to avoid such changes of the presentation picture Pc and reduce the driver's confusion, thus contributing to an improved safety.

As noted previously, the line segment q₀-Q serves as a reference line. The above method discussed in part (A) of FIG. 10 determines the angle η with respect to this reference line. If the same method continues until the vehicle C comes near the end of the slope, most of the resulting presentation picture Pc would be occupied by an image of the road since the reference line would cross the top of the slope as seen in part (B) of FIG. 10. The proposed picture cropping unit 126 therefore calculates a tangent to the downhill road (or line segment q₀-Q_{T}) as seen in part (B) of FIG. 10 and varies the angle η with respect to the calculated line segment q₀-Q_{T}. That is, the picture cropping unit 126 gives a positive angle η so that the line segment q₀-Q_{T} be contained in the view field V. The picture cropping unit 126, however, limits this angular variation at a minimum. More specifically, an appropriate angle η is selected such that the lower boundary of view field V comes close to the line segment q₀-Q_{T} as seen in part (B) of FIG. 10.

Large variations of angle η would produce significant changes in the presentation picture Pc and thus could confuse the driver in recognizing what he or she is seeing. The picture cropping unit 126 is, however, configured to minimize the variation of angle η to avoid such changes of the presentation picture Pc and reduce the driver's confusion, thus contributing to an improved safety.

Part (C) of FIG. 10 illustrates a situation in which the vehicle C has finished the downhill road (Θ<Θ_{Q}). In this situation, the presentation picture Pc obtained with angle η=0 (i.e., when the view field is directed in the direction of a line segment q₀-q₁) would be occupied mostly by an image of the road. Accordingly, the picture cropping unit 126 varies the angle η in the positive direction so that the line segment q₀-Q be contained in the view field V. The picture cropping unit 126, however, limits this angular variation at a minimum. More specifically, an appropriate angle η is selected such that the upper boundary of view field V comes close to the line segment q₀-Q as seen in part (C) of FIG. 10.

Large variations of angle η would produce significant changes in the presentation picture Pc and thus could confuse the driver in recognizing what he or she is seeing. The picture cropping unit 126 is, however, configured to minimize the variation of angle η to avoid such changes of the presentation picture Pc and reduce the driver's confusion, thus contributing to an improved safety.

The above description has discussed in detail how the presentation range is determined dynamically. Although the above description has assumed the use of the first camera 201A, the same description is also applicable to presentation pictures Pc produced from source pictures Pw taken by the second camera 201B.

As can be seen from the above, the presentation range W is properly adjusted according to the road shape R, so as to provide the driver with proper rear views behind his or her vehicle C while complying with relevant legal requirements. This feature also leads to an improved safety.

The above description has provided details of the functions of the view field providing unit 102.

2-3. Process Flows

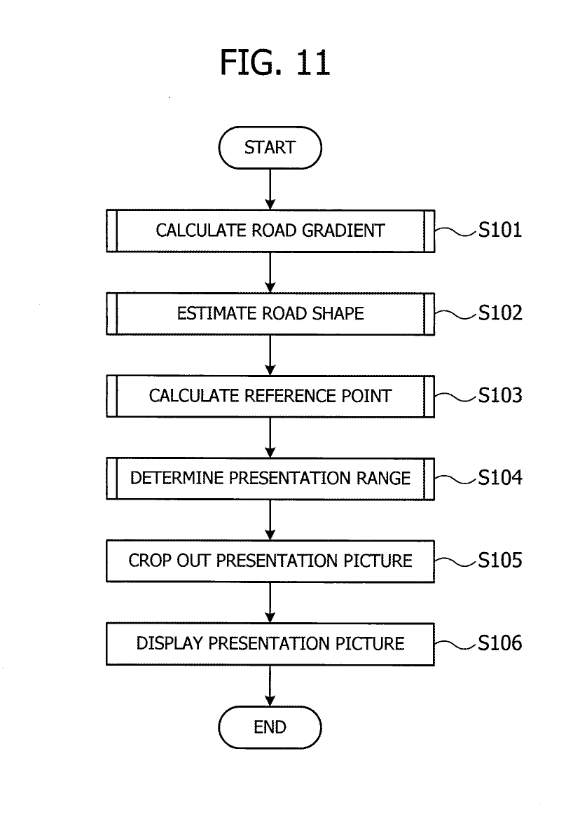

Referring now to FIGS. 11 to 17, this section describes process flows executed by the view field providing unit 102. FIGS. 11 to 17 are first to seventh diagrams, each illustrating a process flow executed by a view field providing unit according to the second embodiment.

(a) Overall Process Flow

Referring to FIG. 11, this subsection describes an overall process flow.

(S101) The road gradient calculation unit 124 calculates road gradients on the basis of acceleration data stored in the storage unit 121. The calculated road gradient data is then stored into the storage unit 121. Note that the storage unit 121 contains acceleration data that the acceleration collection unit 123 has obtained by using a three-axis acceleration sensor or any other accelerometer.

(S102) The reference point calculation unit 125 estimates the road shape on the basis of a time series of road gradient data and a time series of traveling speed data, both available in storage unit 121. Note that the storage unit 121 contains a time series of traveling speed data that the traveling speed collection unit 122 has obtained from the mechanical control unit 101.

(S103) Based on the road shape estimated at step S102, the reference point calculation unit 125 calculates a reference point. The calculated reference point information is stored into the storage unit 121.

(S104) The picture cropping unit 126 determines a presentation range in the current source pictures, based on the reference point information stored in the storage unit 121.

(S105) The picture cropping unit 126 crops out the determined presentation range from each source picture, thereby producing presentation pictures. The produced presentation pictures are then passed to the picture display unit 127.

(S106) The resulting presentation pictures include a first presentation picture cropped out of a source picture taken by the first camera 201A and a second presentation picture cropped out of another source picture taken by the second camera 201B. The picture display unit 127 outputs the first presentation picture to the first monitor 202A and the second presentation picture to the second monitor 202B. Note that the storage unit 121 stores those source pictures taken by the first camera 201A and second camera 201B. The process of FIG. 11 terminates upon completion of step S106.

The above description has explained an overall process flow of the proposed view field providing unit 102. Details of steps S101 to S104 will be described individually in the following subsections (b) to (e).

(b) Process Flow of Road Gradient Calculation

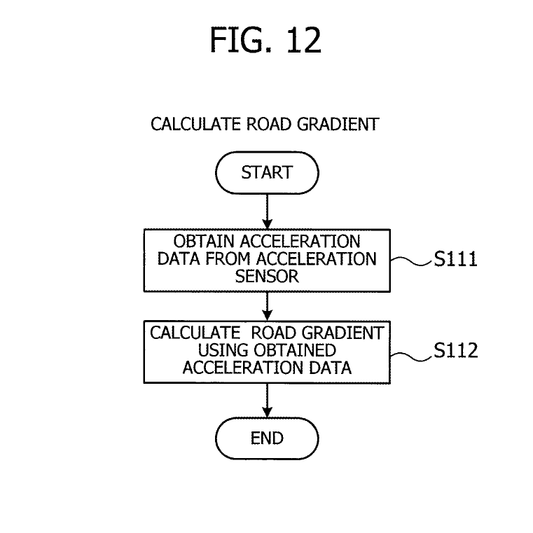

Referring now to FIG. 12, this subsection describes a process flow for road gradient calculation. The process flow of FIG. 12 corresponds to step S101 in FIG. 11.

(S111) The road gradient calculation unit 124 retrieves acceleration data from the storage unit 121. For example, the road gradient calculation unit 124 obtains x-axis acceleration Ax and z-axis acceleration Az (see FIG. 5) measured by a three-axis acceleration sensor at time t.

(S112) The road gradient calculation unit 124 calculates an X-axis acceleration A by assigning the acceleration values Aₓ and A_{z} of step S111, as well as the gravitational acceleration g, into the foregoing equation (3). The road gradient calculation unit 124 then calculates a slope angle Θ by assigning the acceleration values Aₓ, A_{z}, and A and the gravitational acceleration g into the foregoing equation (4). The calculated slope angle Θ is stored into the storage unit 121 as a slope angle Θ(t) representing the road gradient at time t. The road gradient calculation unit 124 exits from the process of FIG. 12 upon completion of step S112.

The above description has provided a detailed process flow of road gradient calculation.

(c) Process Flow of Road Shape Calculation

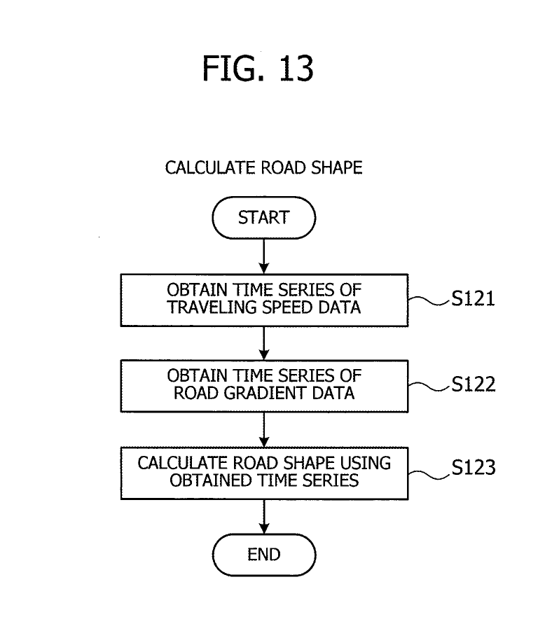

Referring now to FIG. 13, this subsection describes a process flow of road shape calculation. The process flow of FIG. 13 corresponds to step S102 in FIG. 11.

(S121) The reference point calculation unit 125 retrieves a time series of traveling speed data from the storage unit 121. For example, the reference point calculation unit 125 obtains data of traveling speed v(t) at time t (see FIG. 6).

(S122) The reference point calculation unit 125 retrieves a time series of road gradient data from the storage unit 121. For example, the reference point calculation unit 125 obtains data of slope angle Θ(t) at time t (see FIG. 6).

(S123) The reference point calculation unit 125 calculates a road shape from the time series of traveling speed data and road gradient data respectively retrieved at steps S121 and S122. The details are as follows.

First, the reference point calculation unit 125 calculates a travel distance d(t) at time t that represents how much distance the vehicle C has moved during a unit time Δt. This travel distance d(t) can be obtained as v(t) multiplied by Δt.

Then the reference point calculation unit 125 estimates a point (H(t−1), X(t−1)) on the road at time (t−1). Specifically, this point is obtained by tracing backward from the point (H(t), X(t)) by the travel distance d(t) in the direction indicated by the slope angle Θ(t) at time t. The estimated values of H(t−1) and X(t−1) are then stored into the storage unit 121.

The above steps S121 to S123 are executed sequentially and repetitively while varying the time parameter t from the current time t₀ to the past. For example, steps S121 to S123 are repeated until the integral of distance X(t) from time t₀ to time t exceeds a predetermined distance Dₜₕ. The resulting series of H(t) and X(t) values forms time-series data of road shape R (see FIG. 6). The reference point calculation unit 125 exits from the process of FIG. 13 upon completion of step S123.

The above description has provided a detailed process flow of road shape calculation.

(d) Process Flow of Reference Point Calculation

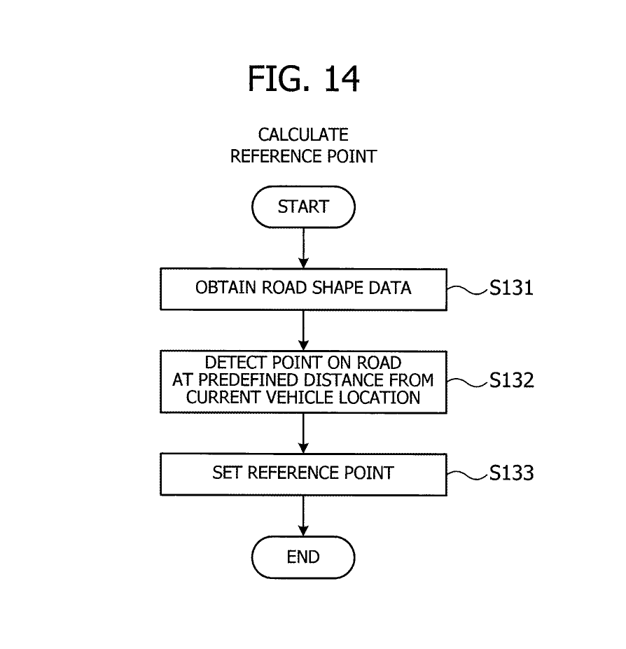

Referring now to FIG. 14, this subsection describes a process flow of reference point calculation. The process flow of FIG. 14 corresponds to step S103 in FIG. 11.

(S131) The reference point calculation unit 125 retrieves time-series data of road shape R from the storage unit 121. For example, the reference point calculation unit 125 retrieves data of elevation H(t) and distance X(t) that has been estimated at step S102 for the road shape R.

(S132) The reference point calculation unit 125 detects a point on the road at a predetermined distance from the current location of vehicle C. For example, the reference point calculation unit 125 calculates a distance D(t) between the current vehicle location at time t₀ and the point on the road shape R at time t. The latter point is expressed as a combination of elevation H(t) and distance X(t). The reference point calculation unit 125 then determines whether the calculated distance D(t) substantially coincides with the predetermined distance Dₜₕ. Some amount of acceptable error (tolerance) is considered in this determination. The reference point calculation unit 125 repeats the above determination while varying time, thereby detecting a point at which distance D(t) substantially coincides with the predetermined distance Dₜₕ.

(S133) The reference point calculation unit 125 selects the point detected at step S132 as a reference point. This reference point information is then stored into the storage unit 121. The reference point calculation unit 125 exits from the process of FIG. 14 upon completion of step S133.

The above description has provided a detailed process flow of reference point calculation.

(e) Process Flow of Presentation Range Determination

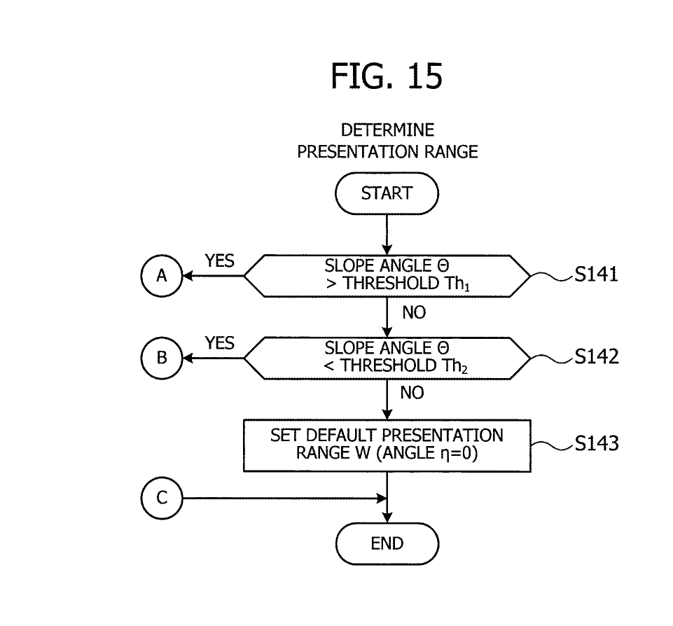

Referring now to FIGS. 15 to 17, this subsection describes a process flow of presentation range determination. The process flow of FIGS. 15 to 17 corresponds to step S104 in FIG. 11. The following explanation will use negative values of slope angle Θ to indicate that the vehicle C is moving in a descending direction with respect to the horizontal plane. Positive values of slope angle Θ indicate that the vehicle C is moving in an ascending direction with respect to the horizontal plane.

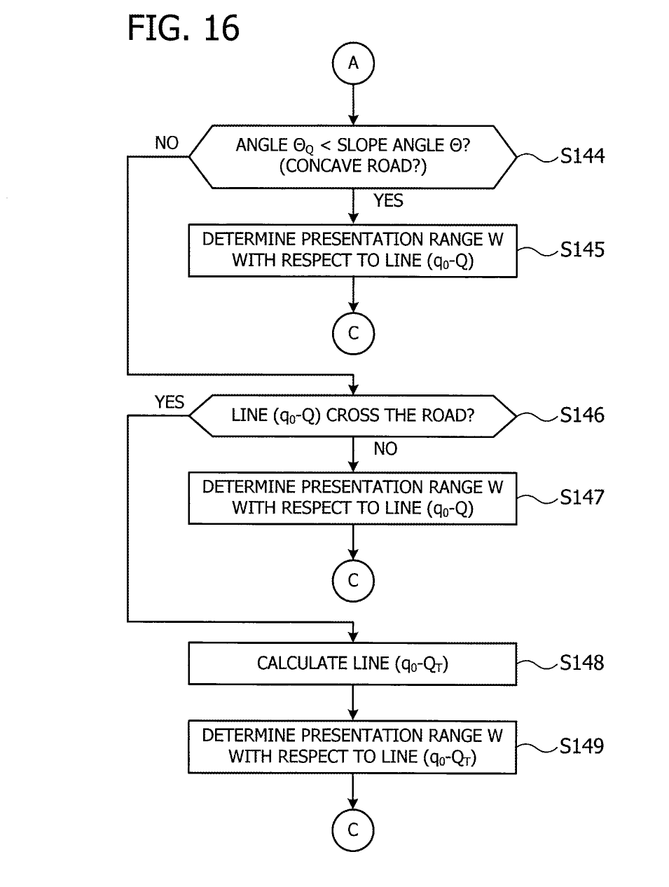

(S141) The picture cropping unit 126 retrieves from the storage unit 121 a slope angle Θ at the current time t₀. The picture cropping unit 126 then determines whether the retrieved slope angle Θ is greater than a first threshold Th₁. If the slope angle Θ is greater than the first threshold Th₁, the process branches to step S144 in FIG. 16. Otherwise, the process advances to step S142.

The first threshold Th₁ is defined beforehand to detect uphill roads and thus has a positive value. For example, the first threshold Th₁ has to be reasonably larger than zero, not to mistakenly recognize small irregularities on the road as an uphill slope. This setup prevents the presentation range W from being overly responsive to minor road irregularities and thus avoids spoiled visibility of presentation pictures. Stable provision of rear views contributes to an improved safety.

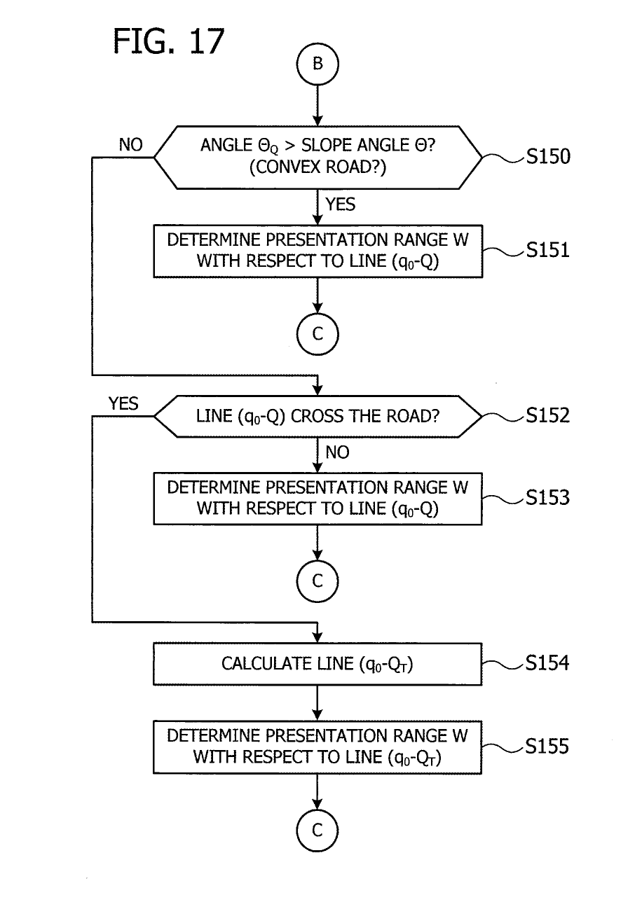

(S142) The picture cropping unit 126 determines whether the slope angle Θ obtained in FIG. 14 is smaller than a second threshold Th₂. If the slope angle Θ is smaller than the second threshold Th₂, the process branches to step S150 in FIG. 17. Otherwise, the process advances to step S143.

The second threshold Th₂ is defined beforehand to detect downhill roads and thus has a negative value. For example, the second threshold Th₂ has to be reasonably smaller than zero, not to mistakenly recognize small irregularities on the road as a downhill slope. This setup prevents the presentation range W from being overly responsive to minor road irregularities and thus avoids spoiled visibility of presentation pictures. Stable provision of rear views contributes to an improved safety.

(S143) The picture cropping unit 126 selects a default range for the presentation range W since this step S143 is executed when the vehicle C is running on a road that appears substantially horizontal. Because no particular slope angle Θ is detected in this situation, no compensation is done for presentation ranges W, but a predefined presentation range W (as default value) is used to deliver presentation pictures Pc to the driver. This default presentation range may be, for example, a presentation range W obtained when the center of the view angle V is aligned with the optical axis of the first camera 201A or second camera 201B. In other words, the default presentation range may be the presentation range W in the case of angle η=0. The process of FIGS. 15 to 17 closes upon completion of step S143.

(S144) The picture cropping unit 126 retrieves information about the reference point Q from the storage unit 121 and calculates an angle Θ_{Q} from the retrieved information. The picture cropping unit 126 then determines whether the calculated angle Θ_{Q} is smaller than the slope angle Θ. This means that the picture cropping unit 126 determines whether the road has a concave form. If the angle Θ_{Q} is smaller than the slope angle Θ, the process advances to step S145. Otherwise, the process moves to step S146.

(S145) The picture cropping unit 126 determines a presentation range W with respect to the line segment q₀-Q. For example, the picture cropping unit 126 gives a positive variation to the angle η such that the view field V contains the line segment q₀-Q (see part (A) of FIG. 8). The picture cropping unit 126, however, limits this angular variation at a minimum. More specifically, an appropriate angle η is selected such that the upper boundary of view field V comes close to the line segment q₀-Q as seen in part (A) of FIG. 8. The process of FIGS. 15 to 17 closes upon completion of step S145.

(S146) The picture cropping unit 126 retrieves time series data of road shape from the storage unit 121 and determines whether the line segment q₀-Q crosses the road. If the line segment q₀-Q is found to cross the road, the process proceeds to step S148. Otherwise, the process advances to step S147.

(S147) The picture cropping unit 126 determines a presentation range W with respect to the line segment q₀-Q. For example, the picture cropping unit 126 gives a negative variation to the angle η such that the view field V contains the line segment q₀-Q (see part (B) of FIG. 8). The picture cropping unit 126, however, limits this angular variation at a minimum. More specifically, an appropriate angle η is selected such that the lower boundary of view field V comes close to the line segment q₀-Q as seen in part (B) of FIG. 8. The process of FIGS. 15 to 17 closes upon completion of step S147.

(S148) The proposed picture cropping unit 126 calculates a tangent to the road (or line segment q₀-Q_{T}) by using the time-series data obtained at step S146 for the road shape (see part (B) of FIG. 9).

(S149) The picture cropping unit 126 determines a presentation range W with respect to the line segment q₀-Q_{T}. For example, the picture cropping unit 126 gives a negative variation to the angle η such that the view field V contains the line segment q₀-Q_{T} (see part (B) of FIG. 9). The picture cropping unit 126, however, limits this angular variation at a minimum. More specifically, an appropriate angle η is selected such that the lower boundary of view field V comes close to the line segment q₀-Q_{T} as seen in part (B) of FIG. 9. The process of FIGS. 15 to 17 closes upon completion of step S149.

(S150) The picture cropping unit 126 retrieves information about the reference point Q from the storage unit 121 and calculates an angle Θ_{Q} from the retrieved information. The picture cropping unit 126 then determines whether the calculated angle Θ_{Q} is larger than the slope angle Θ. This means that the picture cropping unit 126 determines whether the road has a convex form. If angle Θ_{Q} is found to be larger than the slope angle Θ, the process advances to step S151. Otherwise, the process moves to step S152.

(S151) The picture cropping unit 126 determines a presentation range W with respect to the line segment q₀-Q. For example, the picture cropping unit 126 gives a negative variation to the angle η such that the view field V contains the line segment q₀-Q (see part (A) of FIG. 10). The picture cropping unit 126, however, limits this angular variation at a minimum. More specifically, an appropriate angle η is selected such that the lower boundary of view field V comes close to the line segment q₀-Q as seen in part (A) of FIG. 10. The process of FIGS. 15 to 17 closes upon completion of step S151.

(S152) The picture cropping unit 126 retrieves time series data of road shape from the storage unit 121 and determines whether the line segment q₀-Q crosses the road. If the line segment q₀-Q is found to cross the road, the process proceeds to step S154. Otherwise, the process advances to step S153.

(S153) The picture cropping unit 126 determines a presentation range W with respect to the line segment q₀-Q. For example, the picture cropping unit 126 gives a positive variation to the angle η such that the view field V contains the line segment q₀-Q (see part (C) of FIG. 10). The picture cropping unit 126, however, limits this angular variation at a minimum. More specifically, an appropriate angle η is selected such that the upper boundary of view field V comes close to the line segment q₀-Q as seen in part (C) of FIG. 10. The process of FIGS. 15 to 17 closes upon completion of step S153.

(S154) The proposed picture cropping unit 126 calculates a tangent to the road (or line segment q₀-Q_{T}) by using the time-series data obtained at step S152 for the road shape (see part (B) of FIG. 10).

(S155) The picture cropping unit 126 determines a presentation range W with respect to the line segment q₀-Q_{T}. For example, the picture cropping unit 126 gives a negative variation to the angle η such that the view field V contains the line segment q₀-Q_{T} (see part (B) of FIG. 10). The picture cropping unit 126, however, limits this angular variation at a minimum. More specifically, an appropriate angle η is selected such that the lower boundary of view field V comes close to the line segment q₀-Q_{T} as seen in part (B) of FIG. 10. The process of FIGS. 15 to 17 closes upon completion of step S155.

The above description has provided a detailed process flow of presentation range determination.

2-4. Variation #1 (View Control Based on Slope Angles)

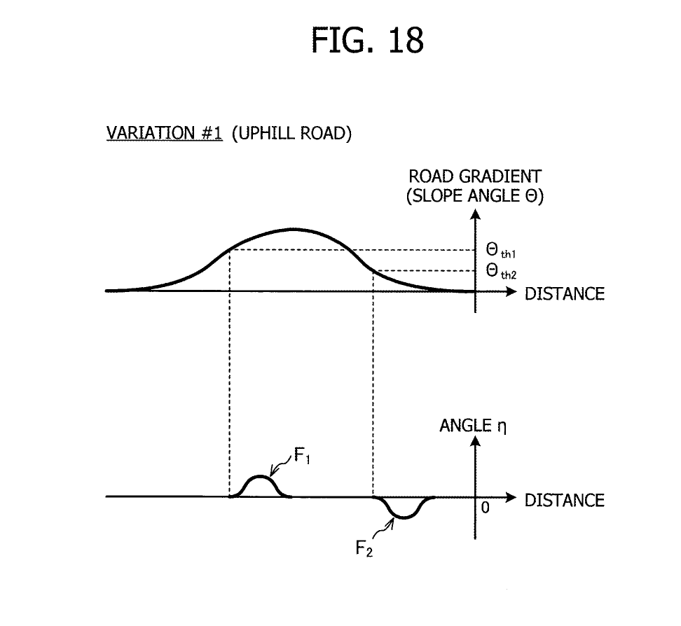

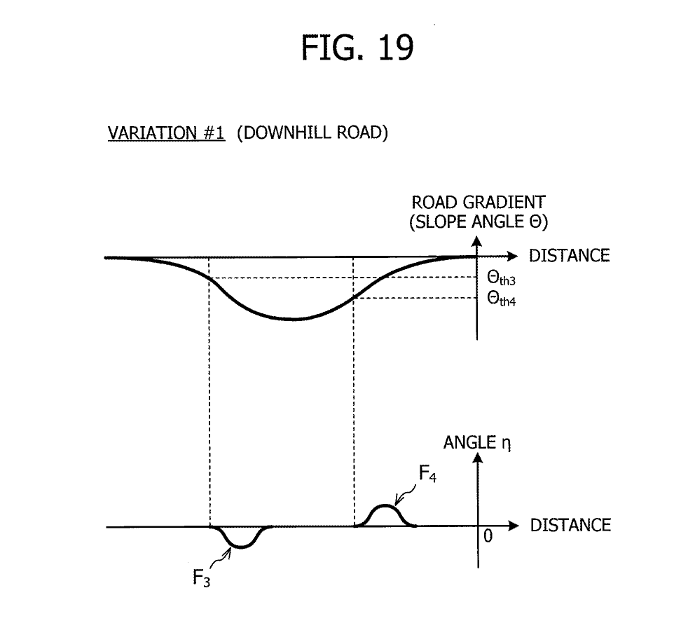

Referring now to FIGS. 18 and 19, this section describes a method for providing view fields according to a variation of the second embodiment (referred to as variation #1). The foregoing view field providing method includes the step of estimating a road shape from a time series of road gradient data. In contrast, variation #1 removes this estimation step, but calculates a compensation angle η directly from detected road gradients. FIGS. 18 and 19 are first and second diagrams illustrating a view field providing method according to variation #1 of the second embodiment.

(a) Uphill Road

FIG. 18 illustrates data of slope angle Θ obtained in the case of an uphill road. Variation #1 controls angle η by using two previously determined thresholds Θₜₕ₁ and Θₜₕ₂. For example, the picture cropping unit 126 varies angle η according to a predefined pattern F₁ when the obtained slope angle Θ exceeds the former threshold Θₜₕ₁. Similarly, the picture cropping unit 126 varies angle η according to another predefined pattern F₂ when the obtained slope angle Θ falls below the latter threshold Θₜₕ₂. Note that the two thresholds Θₜₕ₁ and Θₜₕ₂ are both positive. For example, their values satisfy the following inequality: Θₜₕ₁>Θₜₕ₂>0

Pattern F₁ in the example of FIG. 18 gradually increases the angle η in the positive domain and then gradually returns to zero, when it is triggered upon detection of a slope angle Θ above the threshold Θₜₕ₁. Pattern F₂, on the other hand, gradually increases the angle η in the negative domain and then gradually returns to zero, when it is triggered upon detection of a slope angle Θ below the threshold Θₜₕ₂. For example, the curves of these patterns F₁ and F₂ are determined through experiments, with consideration of travel speeds and road gradients.

(b) Downhill Road

FIG. 19 illustrates data of slope angle Θ obtained in the case of a downhill road. Variation #1 controls angle η by using two previously determined thresholds Θₜₕ₃ and Θₜₕ₄. For example, the picture cropping unit 126 varies angle η according to a predefined pattern F₃ when the obtained slope angle Θ falls below the former threshold Θₜₕ₃. Similarly, the picture cropping unit 126 varies angle η according to another predefined pattern F₄ when the obtained slope angle Θ exceeds the latter threshold Θₜₕ₄. Note that the two thresholds Θₜₕ₃ and Θₜₕ₄ are both negative. For example, their values satisfy the following inequality: Θₜₕ₄<Θₜₕ₃<0

Pattern F₃ in the example of FIG. 19 gradually increases the angle η in the negative domain and then gradually returns to zero, when it is triggered upon detection of a slope angle Θ below the threshold Θₜₕ₃. Pattern F₄, on the other hand, gradually increases the angle η in the positive domain and then gradually returns to zero, when it is triggered upon detection of a slope angle Θ above the threshold Θₜₕ₄. For example, the curves of these patterns F₃ and F₄ are determined through experiments, with consideration of travel speeds and road gradients.

Variation #1 makes it possible to control the presentation range W without the need for estimating road shapes from time-series data of slope angle Θ and travel speed V. In other words, it is possible to reduce the processing load of the electronic control unit 100.

The above description has provided details of an alternative view field providing method according to variation #1.

2-5. Variation #2 (Curve-Conscious View Field Control)

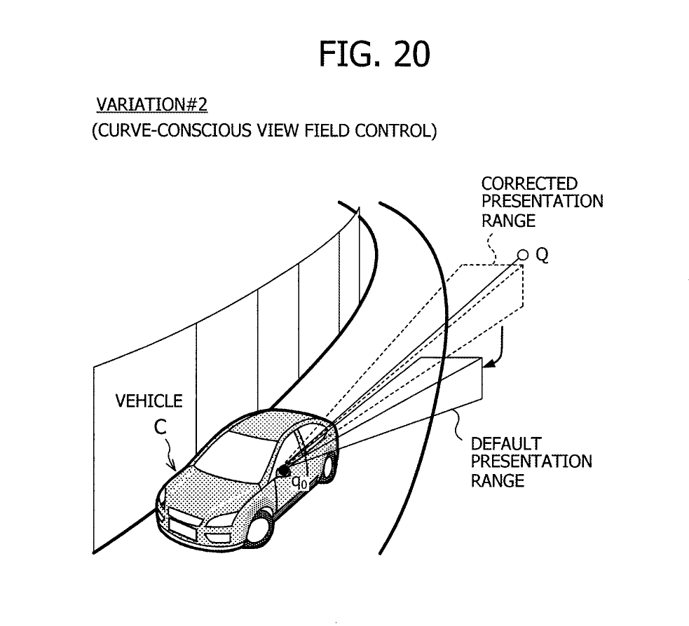

Referring now to FIG. 20, this section will describe yet another method for providing view fields according to another variation of the second embodiment (referred to as variation #2). Variation #2 proposes a method for controlling presentation ranges with consideration of curves. FIG. 20 explains how this method of variation #2 provides appropriate view fields.

As can be seen from FIG. 20, the rear view field may lose track of the road when the vehicle C is taking a sharp curve. If the presentation range W is moved to include farther points in response to a large slope angle Θ, the resulting rear view in the presentation range W would mostly be occupied by other part than the road.

In view of the above problem, variation #2 proposes a mechanism of sensing the curvature of a road that the vehicle C is traveling on, and fixing the presentation range W to its default value upon detection of a large curvature above a predetermined threshold. For example, the road curvature may be evaluated from measurement data of the foregoing three-axis acceleration sensor, and more particularly, on the basis of an acceleration component that is on the horizontal plane and perpendicular to the traveling direction of the vehicle C. It would also be possible to calculate road curvature with data obtained from the Global Positioning System (GPS) or map data, and compare it with a predetermined threshold.

Variation #2 provides an appropriate way to avoid the situation in which non-road part of the rear view occupies almost the entire area of presentation pictures Pc as a result of controlling presentation ranges W on the basis of reference point Q. Accordingly, variation #2 provides the driver with desirable rear views, thus contributing to improved safety.

The above description has provided details of a view field providing method according to variation #2.

2-6. Variation #3 (Information Processing Apparatus with View Control Capability)

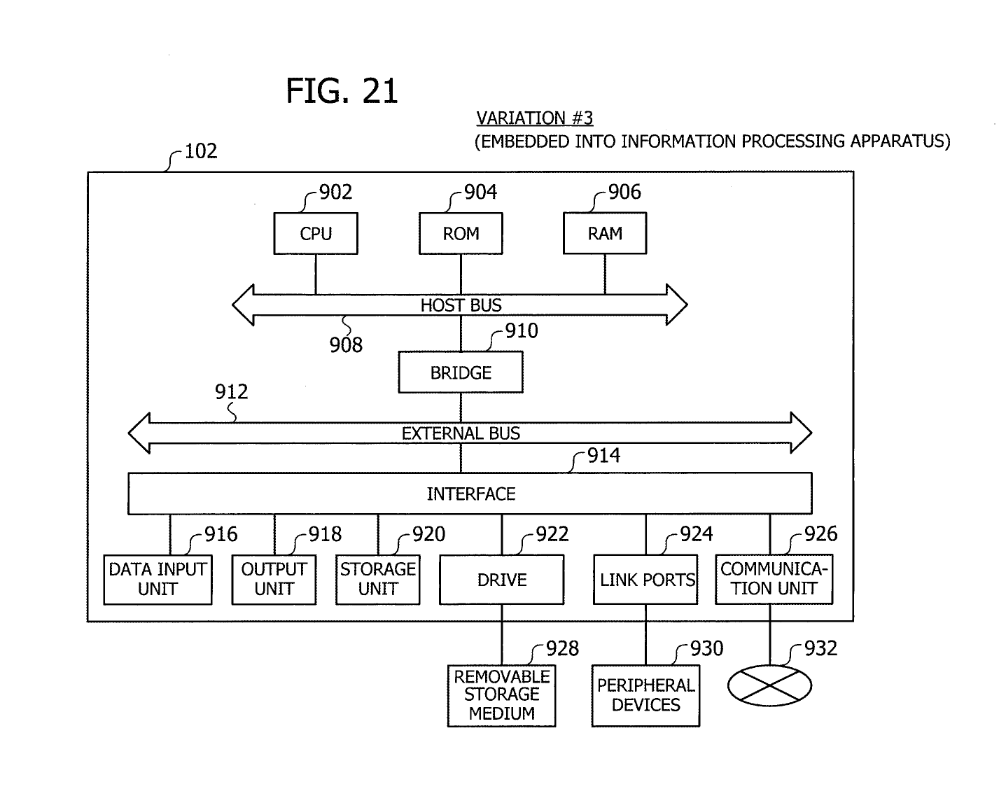

Referring now to FIG. 21, this section describes an information processing apparatus according to still another variation of the second embodiment (referred to as variation #3). It has been assumed in the above description that the electronic control unit 100 executes a view field providing method. Variation #3 proposes a method for implementing the same view field providing method in an information processing apparatus that is different from the electronic control unit 100. FIG. 21 illustrates a hardware configuration of an information processing apparatus according to variation #3 of the second embodiment.

The foregoing view field providing method and its variations may be applied to an information processing apparatus such as an automotive navigation system. Alternatively, a smart phone, personal computer, or some other information processing apparatus may be connected to an automotive navigation system or electronic control unit 100, so that such an information processing apparatus can be used as the view field providing unit 102 discussed above.

When either of these methods is applied, the foregoing functions of the view field providing unit 102 are implemented on an information processing apparatus. For example, FIG. 21 illustrates a hardware platform that permits implementation of those functions on an information processing apparatus. In this case, a computer program is executed to control the illustrated hardware of FIG. 21, thereby providing the functions of the view field providing unit 102.

The hardware platform illustrated in FIG. 21 includes, among other things, a CPU 902, a read-only memory (ROM) 904, a RAM 906, a host bus 908, and a bridge 910. Also included are an external bus 912, an interface 914, an input unit 916, an output unit 918, a storage unit 920, a drive 922, link ports 924, and a communication unit 926.

The CPU 902 functions as, for example, a processor or a controller and controls all or part of the operations of each component, based on various programs stored in the ROM 904, RAM 906, storage unit 920, or removable storage medium 928. The ROM 904 is an example of a storage device that stores programs for the CPU 902 and data used in its computational operations. The RAM 906 serves as a temporary or permanent storage space for programs that the CPU 902 executes, as well as various parameters that may change during execution of those programs.

The above components communicate with each other via, for example, a host bus 908 with a capability of high-speed data transfer. The host bus 908 is further connected with the external bus 912 via a bridge 910, for example. The external bus 912 offers relatively slow data transfer speeds. The input unit 916 may be, for example, a mouse, keyboard, touchscreen, touchpad, buttons, switches, levers, or any combination of them. The input unit 916 may also include a remote controller capable of sending control signals over an infrared link or a radio wave channel.

The output unit 918 may be, for example, a CRT, LCD, PDP, ELD, or any other display device. The output unit 918 may also include audio output devices (e.g., loudspeaker, headphone) and printers. In other words, the output unit 918 is a device that outputs information visually or aurally.

The storage unit 920 is a device for storing various data. For example, the storage unit 920 may include HDDs or other magnetic storage devices. The storage unit 920 may also be semiconductor storage devices such as solid state drives (SSD) and RAM disks, or optical storage devices, or magneto-optical storage devices.

The drive 922 is a device for reading stored data from, or writing data into a removable storage medium 928. The removable storage medium 928 may be, for example, a magnetic disk, optical disc, magneto-optical disc, or semiconductor memory device.

The link ports 924 may include, for example, Universal Serial Bus (USB) ports, IEEE1394 ports, Small Computer System Interface (SCSI) ports, RS-232C ports, optical audio terminals, and the like. These ports may be used to connect peripheral devices 930 such as a printer.

The communication unit 926 is a communication device for connection to a network 932. For example, the communication unit 926 may be a communication circuit for a wired or wireless local area network (LAN), a wireless USB (WUSB) link, an optical communication link, an asymmetric digital subscriber line (ADSL) link, or a mobile network link. The communication unit 926 may also be a router for optical networks or ADSL networks. The network 932 may be a wired or wireless network, including the Internet, LAN, broadcast network, satellite communications link, and the like.

The above description has explained the second embodiment.

Two embodiments and their variations have been disclosed above. As can be seen from these disclosures, the proposed techniques provide the driver with desirable rear views when his or her vehicle climbs up or down a sloping road.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. A display control apparatus comprising:
a memory that stores a source picture taken by a rear view camera attached to a vehicle; and
a controller configured to perform a procedure including:
detecting a road gradient,
calculating a first point on a road that is located at a predetermined distance from the vehicle, based on the detected road gradient,
cropping out a partial area of the source picture such that the partial area includes a second point on a straight line between the rear view camera and the first point on the road, and
displaying a picture of the partial area.

2. The display control apparatus according to claim 1, wherein the detecting of a road gradient includes:
obtaining information about acceleration observed on the vehicle and detecting a road gradient, based on the acceleration.

3. The display control apparatus according to claim 1, wherein the cropping out includes:
cropping out a previously determined area from the source picture when the road gradient is smaller than a specified threshold; and
cropping out a partial area from the source picture such that the partial area includes the second point on the straight line between the rear view camera and the first point on the road, when the road gradient is greater than the specified threshold.

4. The display control apparatus according to claim 1, wherein the calculating of the first point includes:
storing a time series of data representing each road gradient detected at a different time;
calculating a road shape, based on the stored time series of data; and
calculating the first point on the road, based on the calculated road shape.

5. The display control apparatus according to claim 4, wherein the cropping out includes:
calculating a road gradient curve that represents the calculated road shape; and
determining the partial area of the source picture with respect to a tangent to the road gradient curve, when the straight line between the rear view camera and the first point crosses the road gradient curve.

6. The display control apparatus according to claim 1, wherein the procedure further includes:
evaluating a road image ratio that indicates a ratio of an image of the road to an entire area of the partial area; and
adjusting, when the evaluated road image ratio exceeds a predetermined ratio, a location of the partial area in the source picture so as to reduce the road image ratio to below the predetermined ratio.

7. A display control method for a computer that obtains from a memory a source picture taken by a rear view camera attached to a vehicle, the method comprising:
detecting, by the computer, a road gradient;
calculating, by the computer, a first point on a road that is located at a predetermined distance from the vehicle, based on the detected road gradient;
cropping out, by the computer, a partial area of the source picture such that the partial area includes a second point on a straight line between the rear view camera and the first point on the road; and
displaying, by the computer, a picture of the partial area.

8. A computer-readable storage medium storing a program to be executed by a computer that obtains from a memory a source picture taken by a rear view camera attached to a vehicle, wherein the program causes the computer to perform a procedure comprising:
detecting a road gradient;
calculating a first point on a road that is located at a predetermined distance from the vehicle, based on the detected road gradient;
cropping out a partial area of the source picture such that the partial area includes a second point on a straight line between the rear view camera and the first point on the road; and
displaying a picture of the partial area.

9. The display control method according to claim 7, wherein the detecting of a road gradient includes:
obtaining, by a processor in the computer, information about acceleration observed on the vehicle and detecting the road gradient, based on the acceleration.

10. The display control method according to claim 7, wherein the cropping out includes:
cropping out, by a processor in the computer, a previously determined area from the source picture when the road gradient is smaller than a specified threshold; and
cropping out, by the processor, a partial area from the source picture such that the partial area includes the second point on the straight line between the rear view camera and the first point on the road, when the road gradient is greater than the specified threshold.

11. The display control method according to claim 7, wherein the calculating of the first point includes:
storing, by a processor in the computer, a time series of data representing each road gradient detected at a different time;
calculating, by the processor, a road shape, based on the stored time series of data; and
calculating, by the processor, the first point on the road, based on the calculated road shape.

12. The display control method according to claim 7, wherein the procedure further includes:
evaluating, by a processor in the computer, a road image ratio that indicates a ratio of an image of the road to an entire area of the partial area; and
adjusting, by the processor when the evaluated road image ratio exceeds a predetermined ratio, a location of the partial area in the source picture so as to reduce the road image ratio to below the predetermined ratio.
